(19) United States
(12) Patent Application Publication
(10) Pub. No.: US 2014/0133021 A1
(43) Pub. Date: May 15, 2014

(54) Systems and Methods for Enhancing the Brightness Characteristics of a Three-Dimensional Image Viewing Apparatus

(71) Applicants: Hideaki Nakagawa, Houston, TX (US); Monte Ramstad, Cannon Falls, MN (US); Kazuhisa Takahashi, Kanagawa-ken (JP)

(72) Inventors: Hideaki Nakagawa, Houston, TX (US); Monte Ramstad, Cannon Falls, MN (US); Kazuhisa Takahashi, Kanagawa-ken (JP)

(21) Appl. No.: 13/675,840

(22) Filed: Nov. 13, 2012

(51) Int. Cl. G02B 27/22; G02B 7/00

(52) U.S. Cl. CPC G02B 27/22; G02B 7/00
USPC 359/463; 29/407.04

(57) ABSTRACT

The present disclosure describes systems and methods for enhancing the brightness characteristics of a three-dimensional (3-D) image viewing apparatus. According to embodiments of the present disclosure, a 3-D image viewing apparatus may comprise a frame, a first lens disposed within the frame and a second lens disposed within the frame. The first lens may transmit light within a blue spectrum, a green spectrum, and a red spectrum at a first pre-determined intensity. The second lens may transmit light within an amber spectrum and an offset spectrum at a second pre-determined intensity. In certain embodiments, the offset spectrum may comprise a violet spectrum. Additionally, in certain embodiments, at least one of the first and second lenses may comprise a protective, anti-reflective lens

### TECHNICAL FIELD

Embodiments of the disclosure relate generally to three-dimensional image viewing, and more particularly to systems and methods for enhancing the brightness characteristics of a three-dimensional image viewing apparatus.

### BACKGROUND

In recent years, the commercial demand for three-dimensional (3-D) viewing has increased, both in large scale settings, such as movie theatres, and in small-scale settings, such as in home entertainment centers and in healthcare environments. Some typical 3-D viewing systems require the viewer wear a 3-D image viewing apparatus, otherwise known as “3-D glasses,” to perceive the 3-D image. These 3-D glasses can be either active or passive, but typically alter the viewer's perception of the projected image to create the 3-D viewing effect. Using some implementations, the 3-D glasses alter the characteristics of the light received at the viewer's eyes to transmit a stereoscopic image to the viewer. These altered characteristics may, in certain instances, degrade the clarity of the image and create discomfort for the viewer after prolonged use.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein

FIG. 1 shows an example 3-D image generation and viewing system, according to aspects of the present disclosure;

FIG. 2 shows an example image source, according to aspects of the present disclosure;

FIG. 3 shows example emission spectra of an image source, according to aspects of the present disclosure;

FIG. 4 shows example lens filters for 3-D glasses, according to aspects of the present disclosure;

FIG. 5 shows example lens filters for 3-D glasses, according to aspects of the present disclosure;

FIG. 6 shows example color perception spectra of a typical human eye;

FIG. 7 shows example lenses of a 3-D image viewing apparatus according to aspects of the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure

### DETAILED DESCRIPTION

Illustrative embodiments of the present invention are described in detail below. In the interest of clarity, not all features of an actual implementation are described in this specification. It will of course be appreciated that in the development of any such actual embodiment, numerous implementation specific decisions must be made to achieve the developers' specific goals, such as compliance with system related and business related constraints, which will vary from one implementation to another. Moreover, it will be appreciated that such a development effort might be complex and time consuming, but would nevertheless be a routine undertaking for those of ordinary skill in the art having the benefit of the present disclosure.

Embodiments described herein are directed to systems and methods for enhancing the brightness characteristics of a three-dimensional image viewing apparatus. According to embodiments of the present disclosure, a 3-D image viewing apparatus may comprise a frame, a first lens disposed within the frame and a second lens disposed within the frame. The first lens may transmit light within a blue spectrum, a green spectrum, and a red spectrum at a first pre-determined intensity. The second lens may transmit light within an amber spectrum and an offset spectrum at a second pre-determined intensity. In certain embodiments, the offset spectrum may comprise a violet spectrum. Additionally, in certain embodiments, at least one of the first and second lenses may comprise a protective, anti-reflective lens.

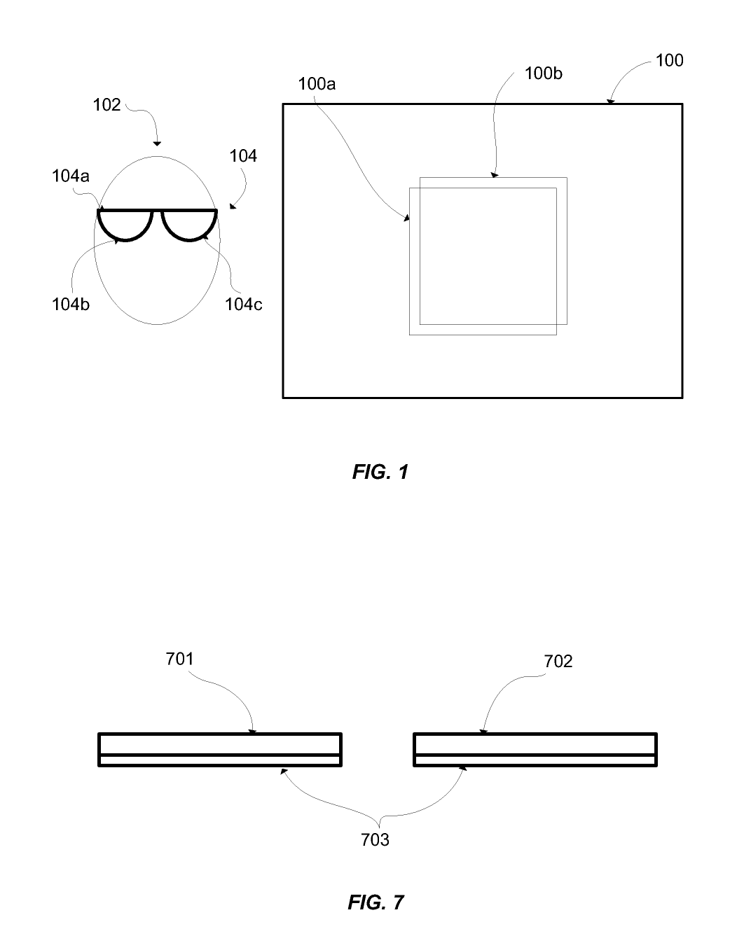

FIG. 1 illustrates an example 3-D image generation system, or image source 100, being viewed by an example viewer 102. The 3D image source may comprise, for example, a 3-D compatible television, a movie screen, a computer monitor, or other image sources well known in the art. In certain embodiments, the image source 100 may comprise a 3-D compatible television incorporating light emitting diode (LED)/liquid crystal display (LCD) elements. The image source 100 may incorporate anaglyphic 3-D technology, displaying a first stereographic image 100a in a first color emission spectrum and displaying a second stereographic image 100b in a second color emission spectrum. The image source 100 may display the first stereographic image 100a in the first color emission spectrum by using a filter, for example, or emitting light from a first set of LEDs that generate light in the first color emission spectrum. Likewise, the image source 100 may display the second stereographic image 100b in the second color emission spectrum by using a filter or emitting light from a second set of LEDs that generate light in the second color emission spectrum.

The user 102 may view the images displayed be image source 100 through 3-D glasses 104. The 3-D glasses may include a frame 104a, a first lens 104b, and a second lens 104c. In certain embodiments, the frame 104a may be made of plastic, metal, cardboard, or other suitable strong material well known in the art. Likewise, the first lens 104b and second lens 104c may be may of plastic, glass, or other materials well known in the art; may take a variety of shapes and sizes; and may be flat, convex, concave, or some combination of the three. As will be described below, the lenses 104b and 104c may be configured to block one of the stereoscopic images and transmit the other stereoscopic image, such that each stereoscopic image is received at a different eye of the viewer, which the user's visual cortex then combines to form a 3-D image.

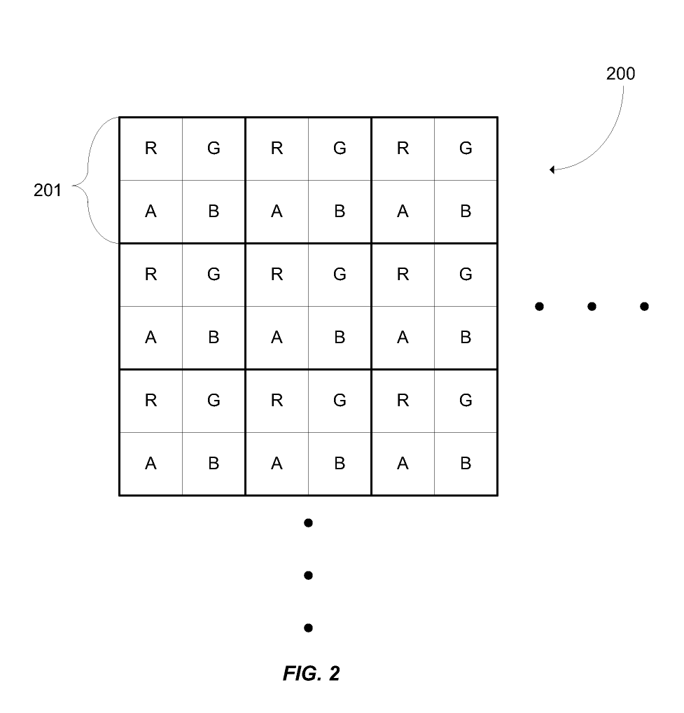

FIG. 2 illustrates an example image source 200, comprising an array of unit elements with different colored pixels. In FIG. 2, unit element 201 includes an LED which emits light within the amber color spectrum (A), an LED which emits light within the green color spectrum (G), an LED which emits light within the blue color spectrum (B), and an LED which emits light in the red color spectrum (R). The unit element 201 may comprise a semiconductor element, as will be described below, and each of the four color emission spectra R, G, B, and A emitted from the semiconductor elements may be addressed a separate pixels, allowing each color to be emitted separately. Additionally, although a unit element with four color pixels are shown, semiconductor elements with less that four colors are possible. For example, some unit element may include only three colors—red, green, and blue—but with fewer or more than four pixels.

In certain embodiments, as will be describe in greater detail below, the image source 200 may display a first stereoscopic image using light within an amber color spectrum, and may display the second stereoscopic image 100b using light within a red color spectrum, a blue color spectrum, and a green color spectrum. The amber color spectrum may correspond to light with a wavelength between approximately 570 and 590 nanometers (nm). The red color spectrum may correspond to light with a wavelength between approximately 620 and 740 nm. The green color spectrum may correspond to light with a wavelength between approximately 520 to 570 nm. And the blue color spectrum may correspond to light with a wavelength between approximately 450-495 nm. As is well understood by those in the art, the precise limits of each color spectra are inexact. Additionally, the ranges above are for the color spectrum corresponding to each color, but the color actually emitted from the semiconductor element, the color emission spectrum, may be a subset of the wavelengths within the range. For example, the G pixel LED may be configured to emit light within the green spectra primarily at a wavelength of 540 nm.

In certain embodiments, the 3-D glasses may correspond to the image source, meaning the 3-D glasses are configured according to the color emission spectra of the image source. For example, each of the lenses of the 3-D glasses may include filter characteristics that correspond to particular wavelengths of light that the pixels of the image source are configured to emit. If, as described above, the image source 200 displays a first stereoscopic image 100a using an amber color emission spectrum, and displays a second stereoscopic image 100b using a red color emission spectrum, a blue color emission spectrum, and a green color emission spectrum, a first lens may transmit light within the subset of the amber color spectrum, while substantially blocking light within the red, blue, and green color emission spectra. Likewise, the second lens may transmit light within the red, blue, and green color emission spectra, while substantially blocking the amber color emission spectrum. The lens may transmit light by allowing it to pass through the lens to the viewer, and may block the light by absorbing the light within the lens and preventing it from passing through to the viewer. Additionally, substantially blocking a color spectrum may include preventing most of or the entire selected color spectrum from being transmitted through the lens; although manufacturing limitations and design choices may make completely blocking a particular color spectrum practically impossible, prohibitively expensive, or otherwise undesirable.

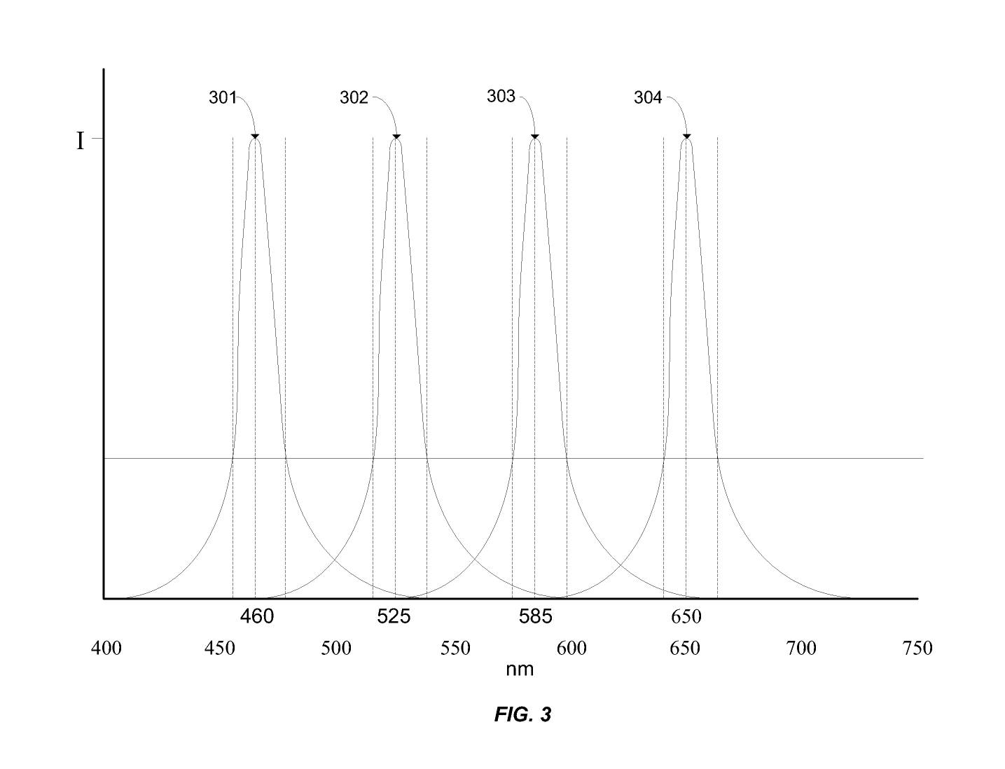

FIG. 3 illustrates an example plot of the A, R, B, and G emission spectra of the pixels of the semiconductor element 201 from FIGS. 2, plotted as the wavelength of the light in nanometers (nm) versus a normalized light intensity I. Emission spectrum 301 corresponds to the B pixel, with the light emitted at its maximum intensity at 460 nm, and with the primary intensity of the emission spectrum 301 being at a wavelength between +/−5 to 10 nm of the 460 nm wavelength. Emission spectrum 302 corresponds to the G pixel, with the light emitted at its maximum intensity at 525 nm, and with the primary intensity of the emission spectrum 302 being at a wavelength between +/−5 to 10 nm of the 525 nm wavelength. Emission spectrum 303 corresponds to the A pixel, with the light emitted at its maximum intensity at 585 nm, and with the primary intensity of the emission spectrum 303 being at a wavelength between +/−5 to 10 nm of the 585 nm wavelength. Emission spectrum 304 corresponds to the A pixel, with the light emitted at its maximum intensity at 585 nm, and with the primary intensity of the emission spectrum 303 being at a wavelength between +/−5 to 10 nm of the 585 nm wavelength. Other spectra are possible, including spectra without one or more of the color elements, as would be appreciated by one of ordinary skill in the art in view of this disclosure.

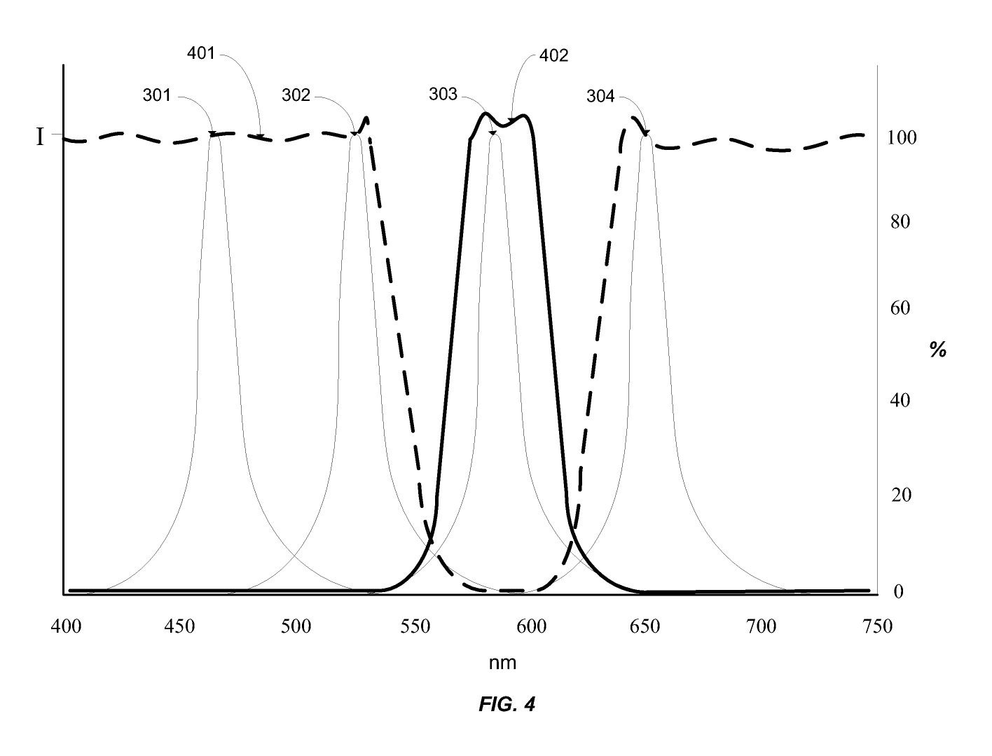

FIG. 4 illustrates the example plot of FIG. 3, over laid with a plot representing the filter characteristics of example 3-D glasses lenses, plotted in terms of wavelength in nm and the percentage of normalized intensity I of the light which the filters allow to be transmitted though the corresponding lens. The combined plot shows how the filters interact with the emission spectra discussed above. The first lens filter 401 may comprise a broad base filter, transmitting light within the B pixel emission spectrum 301, the G pixel emission spectrum 302, and the R pixel emission spectrum 304. The first lens filter 401 may transmit the B, G, and R emission spectra with an intensity of around 100%, depending on material limitations. In other words, almost all of the light emitted by the image source within those spectra will be received through the first lens. The first lens filter 401 may also substantially block the light within the A pixel emission spectrum 303 from being transmitted through the first lens. Notably, as discussed above, this allows the image source to display one stereoscopic image using light within the A pixel emission spectrum that is not seen (or mostly not seen due to ghosting) through the first lens.

In contrast to the first lens filter 401, the second lens filter 402 may comprise more of a limited band pass, centered on the A pixel emission spectrum 303. The second lens filter 302 may transmit light within the A pixel emission spectrum 303 with an intensity of around 100%, depending on material limitations. The second lens filter 402 may also substantially block the light within the B pixel emission spectrum 301, the G pixel emission spectrum 302, and the R pixel emission spectrum 304 from being transmitted through the second lens. Notably, as discussed above, this allows the image source to display one stereoscopic image using light within the B, G, and R pixel emission spectra that is not seen (or mostly not seen due to ghosting) through the second lens. Thus, the first stereoscopic image (with light from the A pixel emission spectrum) and the second stereoscopic image (with light from the G, B, and R pixel emission spectra) may be received separately through different lenses, where the viewer's visual cortex forms a three-dimensional image of substantially white light by combining both the stereoscopic images and the color spectra of the images.

One problem with the first and second lens filter configurations show in FIG. 4 is the brightness imbalance between the first lens and the second lens. Notably, the first lens filter 401 transmits a much broader range of light, including the B, G, and R pixel emission spectra 301, 302, and 303, respectively. In contrast, the second lens filter is centered around and transmits only the light within the A pixel emission spectrum 303, which represents significantly less energy that the combined light allowed through the first lens filter 401. Additionally, when light within the B, G, and R pixel emission spectra is received at the viewer's eye, that light is perceived as white light, as will be discussed below, which may increase the perceived brightness of the light received through the first lens, as compared to the second lens. This imbalance in brightness between the lenses can degrade the 3-D image quality perceived by the viewer, as well as cause discomfort for the viewer after prolonged use.

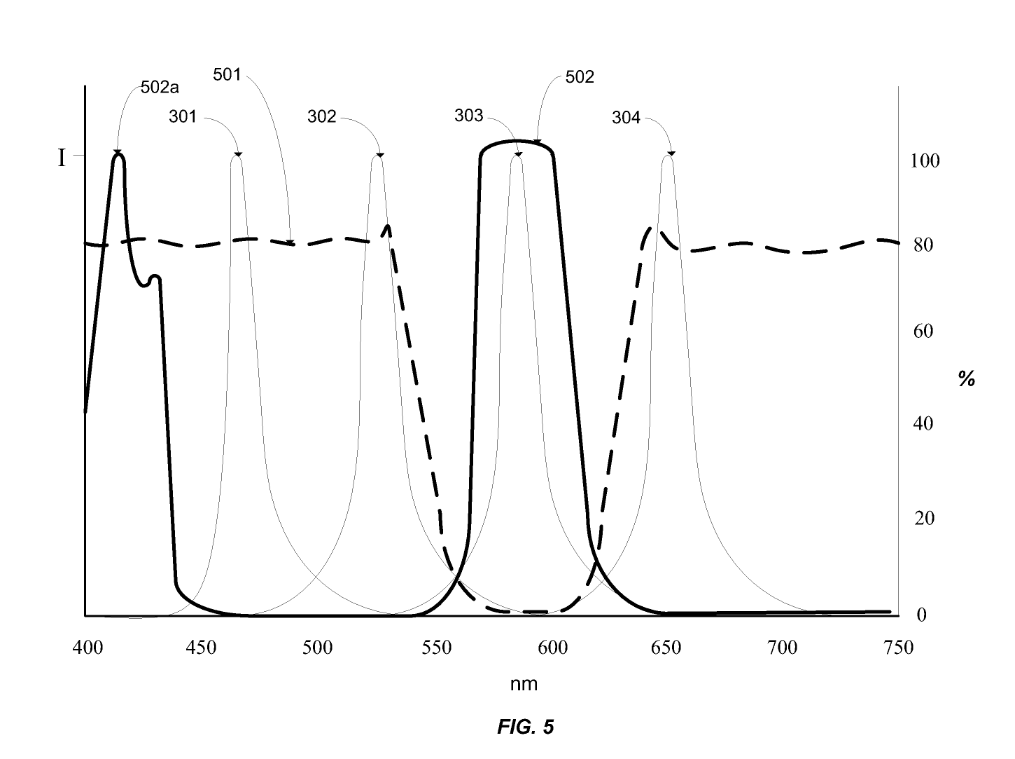

FIG. 5 illustrates modified lens filter configurations incorporating aspects of the present disclosure, which may adjust for the brightness imbalance between the two lenses. In particular, FIG. 5 illustrates the example plot of FIG. 3, over laid with a plot representing the optimized filter characteristics, plotted in terms of wavelength in nm and the percentage of normalized intensity I of the light which the filters allow to be transmitted though the corresponding lens. Notably, the first lens filter 501 transmits light within the B, G, R pixel emission spectra, 301, 302, and 304, respectively, at a first pre-determined intensity. In the embodiment shown, the first-predetermined intensity is approximately 80% of the maximum intensity of the B, G, and R light. In other embodiments, the first-predetermined intensity may take other values depending on the application, or may be less than or equal to 80% of the maximum intensity of the B, G, and R light. Likewise, more than one pre-determined intensity may be used such that light within the B pixel emission spectrum 301 is transmitted at a different intensity that light in the G pixel emission spectrum 302.

As can be seen, the intensity of the light within the A pixel emission spectrum 303 may be 100% in the second lens filter 502. Reducing the intensity of the light transmitted through the first lens, and maintaining the intensity of the light within the second lens, may partially adjust for the brightness imbalance between the two lenses. Additionally, the second lens filter 502 may transmit an offset spectrum 502a through the second lens. As can be seen, the offset spectrum 502 a may be centered within an empty emission spectrum of an image source. Practically speaking, an “empty” emission spectrum may include some of the emitted spectra from the image source, but should be selected such that less that 10% of the emitted light intensity exists at the center wavelength.

In the example shown, the offset spectrum may be centered within a violet spectrum, or at about 420 nm. In certain embodiments, the offset spectrum may be selected once the emission spectra of the image source have been identified. Once the emission spectra have been identified, the offset spectrum can be selected such that it does not substantially overlap with another emission spectrum. Although the offset spectrum may overlap to a certain degree with an emission spectrum, the offset spectrum can selected to minimize overlap, and therefore minimize any image ghosting that may occur in the second lens.

In addition to increasing the overall amount of light energy received through the second lens—and therefore increasing the brightness of the image received through the second lens—the offset spectrum may further be selected such that light within the offset spectrum may combine with light within the other color spectra transmitted through the second lens to create white light. This white light may more closely resemble the white light perceived through the first lens, and therefore decrease the brightness imbalance.

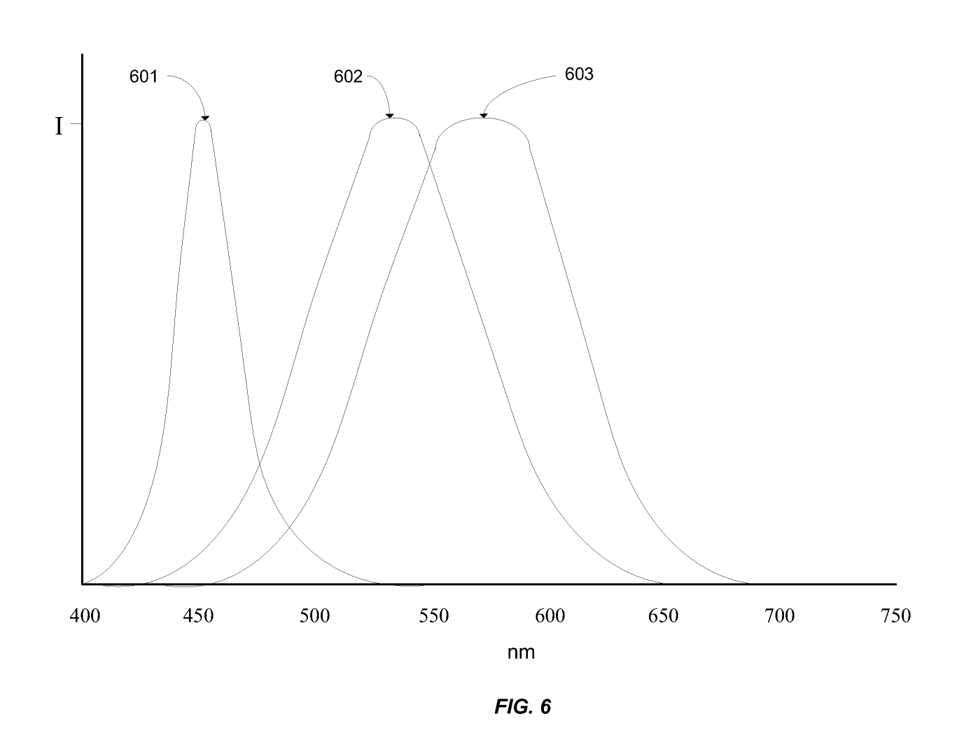

FIG. 6 illustrates an example plot reflecting the typical light wavelengths that are perceived with the rods and cones of a typical human eye. Spectrum 601 corresponds to rods and cones of the human eye which detect short wavelength light, such as violet and blue. Spectrum 602 corresponds to rods and cones of the human eye which detect medium wavelength light, such as green. Spectrum 603 corresponds to rods and cones of the human eye which detect long wavelength light, such as red. Notably, there is significant overlap between the color spectra which the rods and cones detect. Typically, the human eye perceives light as “white” when each of the rods and cones corresponding to the short, medium, and long wavelengths perceive light. In the case of the first lens filter described above, the B pixel emission spectra 301 would overlap with spectrum 601, thus being perceived by the short wavelength rods and cones; the G pixel emission spectrum 302 would overlap with spectra 602 and 603, thus being perceived by both medium and long wavelength rods and cones; and the R pixel emission spectrum 304 would overlap with spectrum 603, thus being perceived by the long wavelength rods and cones. Accordingly, the light transmitted through the first lens would be perceived as white.

In contrast, if the second lens filter transmits only light within the A pixel emission spectrum 303, only the medium and long wavelength rods and cones would perceive light. Thus, to create a perception of “white” light within the second lens, the short wavelength rods and cones would also need to perceive light. In the example shown in FIG. 5, by selecting an offset spectrum in the violet spectrum, the short wavelength rods and cones would also perceive light, thus creating a perception of white light by the viewer, and decreasing the brightness imbalance.

FIG. 7 illustrates a cross section of example lenses 701 and 702. In certain embodiments, a first filter may be imparted to first lens 701 and a second filter may be imparted to second lens 702. Imparting the filters to the lenses may include, for example, incorporating chemical combinations during the manufacturing process such that the entire lens acts to filter the light. In contrast, imparting a filter may include inlaying a filter layer within the lens itself. Other methods for creating the filter characteristics are possible, as would be appreciated by one of ordinary skill in view of this disclosure.

In certain embodiments, at least one of the lenses 701 and 702 may include a protective, anti-reflective layer 703. The layer 703 may be placed on an interior or exterior surface of the lenses 701 and 702. Notably, the layers 703 may protect the user's eye in the case of one of the lenses shattering. Likewise, by incorporating the anti-reflective coating, a clearer 3-d image may be perceived by the user with less interference from glare.

While certain embodiments of a 3-D image viewing apparatus have been described; these embodiments have been presented by way of example only, and are not intended to limit the scope of the disclosure. Indeed, the novel systems described herein may be embodied in a variety of other forms; furthermore, various omissions, substitutions and changes in the form of the systems described herein may be made without departing from the spirit of the disclosure. The accompanying claims and their equivalent are intended to cover such forms or modifications as would fall within the scope and spirit of the disclosure.

What is claimed is:

1. A three-dimensional (3-D) image viewing apparatus, comprising:
a frame;
a first lens disposed within the frame, wherein the first lens transmits light within a first color spectrum at a first pre-determined intensity;
a second lens disposed within the frame, wherein the second lens transmits light within a second color spectrum and an offset spectrum with a second pre-determined intensity, and
wherein the first pre-determined intensity is less than the second pre-determined intensity.

2. The 3-D image viewing apparatus of claim 1, wherein
the second color spectrum comprises an amber spectrum, and the amber spectrum corresponds to an amber emission spectrum of the image source, and
wherein the offset spectrum is centered at a substantially empty emission spectrum of the image source.

3. The 3-D image viewing apparatus of claim 2, wherein the first color spectrum comprises a red spectrum, a green spectrum, and a blue spectrum, wherein the red spectrum corresponds to a red emission spectrum of the image source, the blue spectrum corresponds to a blue emission spectrum of the image source, and the green spectrum corresponds to a green emission spectrum of the image source.

4. The 3-D image viewing apparatus of claim 1, wherein at least one of the first lens and the second lens comprises a protective, anti-reflective film.

5. The 3-D image viewing apparatus of claim 2, wherein light within the amber spectrum and the offset spectrum combines to form white light.

6. The 3-D image viewing apparatus of claim 3, wherein the second pre-determined intensity is less than or equal to 80% of the maximum intensity of light within the blue emission spectrum, the green emission spectrum, and the red emission spectrum.

7. The 3-D image viewing apparatus of claim 6, wherein the first pre-determined intensity is greater than or equal to 95% of the maximum intensity of light within the amber emission spectrum and the offset spectrum.

8. A three-dimensional (3-D) image generation and viewing system, comprising:
an image source, wherein the image source emits light within a blue emission spectrum, a green emission spectrum, a red emission spectrum, and an amber emission spectrum; and
a 3-D image viewing apparatus corresponding to the image source, wherein the 3-D image viewing apparatus comprises:
a frame
a first lens disposed within the frame, wherein the first lens transmits light within the blue emission spectrum, the green emission spectrum, and the red emission spectrum at a first pre-determined intensity;
a second lens disposed within the frame, wherein the second lens transmits light within the amber emission spectrum and an offset spectrum at a second pre-determined intensity,
wherein the first pre-determined intensity is less than the second pre-determined intensity.

9. The 3-D image generation and viewing system of claim 8, wherein the image source displays a first stereographic image using light within the amber emission spectrum, and displays a second stereographic image using light within the blue emission spectrum, the green emission spectrum, and the red emission spectrum.

10. The 3-D image generation and viewing system of claim 9, wherein the offset spectrum is centered at a substantially empty emission wavelength of the image source.

11. The 3-D image generation and viewing system of claim 8, wherein at least one of the first lens and the second lens comprises a protective, anti-reflective film.

12. The 3-D image generation and viewing system of claim 8, wherein light within the amber emission spectrum and the offset spectrum combines to form white light.

13. The 3-D image generation and viewing system of claim 8, wherein the second pre-determined intensity is less than or equal to 80% of the maximum intensity of light within the blue emission spectrum, the green emission spectrum, and the red emission spectrum.

14. The 3-D image generation and viewing system of claim 13, wherein the first pre-determined intensity is greater than or equal to 95% of the maximum intensity of light within the amber emission spectrum and the offset spectrum.

15. A method for manufacturing a three-dimensional (3-D) image viewing apparatus, comprising:
identifying an emission spectra of an image source;
determining an offset spectrum based, at least in part, on the emission spectra;
imparting a first filter to a first lens of the 3-D image viewing apparatus, wherein the first filter transmits light within a first portion of the emission spectra with at least one first pre-determined intensity;
imparting a second filter to a second lens of the 3-D image viewing apparatus, wherein the second filter transmits light within a second portion of the emission spectra and an offset spectrum with at least one second pre-determined intensity,
wherein the at least one first pre-determined intensity is less than the at least one second pre-determined intensity.

16. The method of claim 15, wherein light within the second portion of the emission spectra and the offset spectrum combine to form white light.

17. The method of claim 16, further comprising applying to at least one of the first lens and the second lens a protective, anti-reflective film.

18. The method of claim 15, wherein the emission spectra comprises a blue emission spectrum, a green emission spectrum, an amber emission spectrum, and a red emission spectrum.

19. The method of claim 16, wherein the first portion of the emission spectra comprises the blue emission spectrum, the green emission spectrum, and the red emission spectrum, and wherein the second portion of the emission spectra comprises the amber emission spectrum.

20. The method of claim 19, wherein the at least one second pre-determined intensity is less than or equal to 80% of the maximum intensity of light within the blue emission spectrum, the green emission spectrum, and the red emission spectrum, wherein the a least one first pre-determined intensity is greater than or equal to 95% of the maximum intensity of light within the amber emission spectrum and the offset spectrum.
